(19) United States
(12) Patent Application Publication
(10) Pub. No.: US 2025/0052373 A1
(43) Pub. Date: Feb. 13, 2025

(54) CLOSED-LOOP NET POSITIVE SUCTION PRESSURE CONTROL FOR CRYOGENIC LIQUID PUMP

(71) Applicant: Chart Inc., Ball Ground, GA (US)

(72) Inventors: Joshua Steffen, Prior Lake, MN (US); Paul Drube, Lakeville, MN (US); Luke Gasperlin, Hopkins, MN (US)

(21) Appl. No.: 18/798,290

(22) Filed: Aug. 8, 2024

Related U.S. Application Data
(60) Provisional application No. 63/518,470, filed on Aug. 9, 2023.

(51) Int. Cl. F17C 7/02

(52) U.S. Cl. CPC F17C 7/02; F17C 2201/0109; F17C 2205/0326; F17C 2205/0352; F17C 2221/012; F17C 2223/0161; F17C 2223/035; F17C 2227/0142; F17C 2227/0178; F17C 2250/03; F17C 2250/043; F17C 2250/0439; F17C 2250/0636

(57) ABSTRACT

Systems and methods for reducing cavitation of a pump in a liquid transfer system including a pump and a liquid storage tank. More particularly, systems and methods for maintaining and adjusting Net Positive Suction Pressure (NPSP) are provided to the pump.

### CLAIM OF PRIORITY

This application claims the benefit of U.S. Provisional Application No. 63/518,470, filed Aug. 9, 2023, the contents of which are hereby incorporated by reference.

### FIELD OF THE DISCLOSURE

The present disclosure relates systems and methods for preventing cavitation of liquid in a pump in a liquid transfer system. More particularly, the present disclosure relates to closed-loop systems and methods for maintaining and/or adjusting Net Positive Suction Pressure (NPSP) provided to a pump in a cryogenic liquid transfer system.

### BACKGROUND

When operating a cryogenic pump, whether it is centrifugal or reciprocating, some amount of Net Positive Suction Head (NPSH) is required to ensure the pump does not cause boiling of the liquid as it enters the pump. This is sometimes referred to as cavitation or “loss of prime”. If NPSH is listed in units of pressure rather than a length of head, then it is called Net Positive Suction Pressure (NPSP). NPSP is the amount of pressure above the saturation pressure for a given temperature liquid.

It is standard industry practice for pump manufacturers to state on their datasheet what the required NPSP is for the pump to run without cavitation. In this case, the acronym can be changed to NPSHr or NPSPr where the r stands for “required”.

In certain pump applications, simply meeting the NPSPr may not be sufficient to achieve the desired results. Certain cryogens, in particular liquid hydrogen (LH₂), are more susceptible to issues with NPSPr. In these cases, the pump's flow rate may increase when NPSP is increased beyond the minimum required level. Without a method of controlling the NPSP, the pump results may vary drastically and be unpredictable, which may disturb the downstream process or customer.

Another related issue is that the traditional method of adding NPSP to a pump to prevent cavitation is to pressure build the tank feeding the pump. This is done by taking a small amount of the liquid stored in the tank and running it through a heater (usually an ambient air heat exchanger or vaporizer) and returning the warmed fluid, now a vapor, to the head space of the bulk tank. This increases the pressure of the tank, as illustrated by the phase diagram in FIG. 1, while not warming much of the liquid up, so that the liquid is no longer on the saturation curve. A problem with this is that the extra heat added to build pressure within the tank will eventually transfer through the fluid and cause the liquid to warm up faster than it would normally. This results in the liquid eventually returning to the saturation curve, but at a higher pressure than it was previously. In many processes, this may require venting of the storage tank to return it to the desired pressure, wasting some of the stored fluid in the process. Accordingly, if pressure-build is to be performed, it is desirable to limit it to only what is required.

Therefore, there is a need for improved methods and systems for controlling NPSP.

### SUMMARY OF THE DISCLOSURE

There are several aspects of the present subject matter which may be embodied separately or together in the methods, devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a cryogenic liquid transfer system includes a storage tank configured to contain a cryogenic liquid. A pump is in fluid communication with the storage tank and is configured to pump liquid out of the storage tank. A temperature sensor and a pressure sensor are configured to measure a temperature and pressure of cryogenic liquid upstream of the pump. A pressure-building circuit includes a pressure-building valve. A controller is configured to determine a Net Positive Suction Pressure provided to the pump based on measurements from the temperature sensor and the pressure sensor and adjust the determined Net Positive Suction Pressure by manipulation of the pressure-building valve to provide a target Net Positive Suction Pressure to the pump.

In another aspect, A method for preventing cavitation in a cryogenic liquid transfer system including a storage tank and a pump includes the steps of determining a Net Positive Suction Pressure provided to the pump by measuring a temperature and a pressure of a cryogenic liquid upstream of the pump and adjusting the Net Positive Suction Pressure to a target Net Positive Suction Pressure based on the measured temperature and pressure.

### BRIEF DESCRIPTION OF THE DRAWINGS

FIG. 1 is a phase diagram illustrating the creation of NPSP for a pump by directing vapor to the head space of a tank used to supply liquid to the pump.

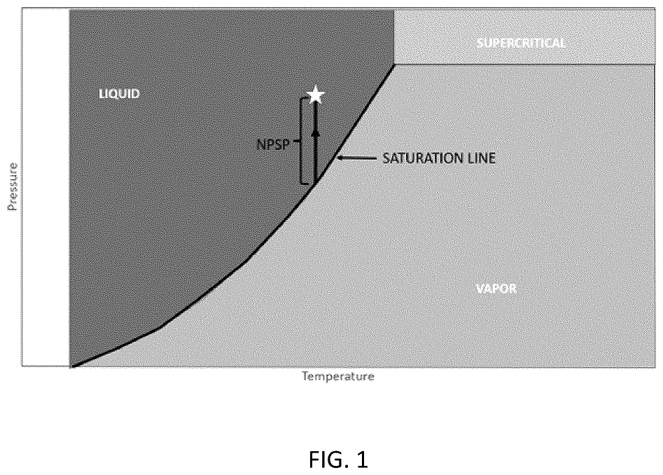

FIG. 2 is a schematic illustration of a first embodiment of the closed-loop NPSP control system of the disclosure.

FIG. 3 is a schematic illustration of a second embodiment of the closed-loop NPSP control system of the disclosure.

### DETAILED DESCRIPTION OF EMBODIMENTS

A more detailed description of the system and method in accordance with the present disclosure is set forth below. It should be understood that the description below of specific systems and methods is intended to be exemplary, and not exhaustive of all possible variations or applications. Thus, the scope of the disclosure is not intended to be limiting and should be understood to encompass variations or embodiments that would occur to persons of ordinary skill.

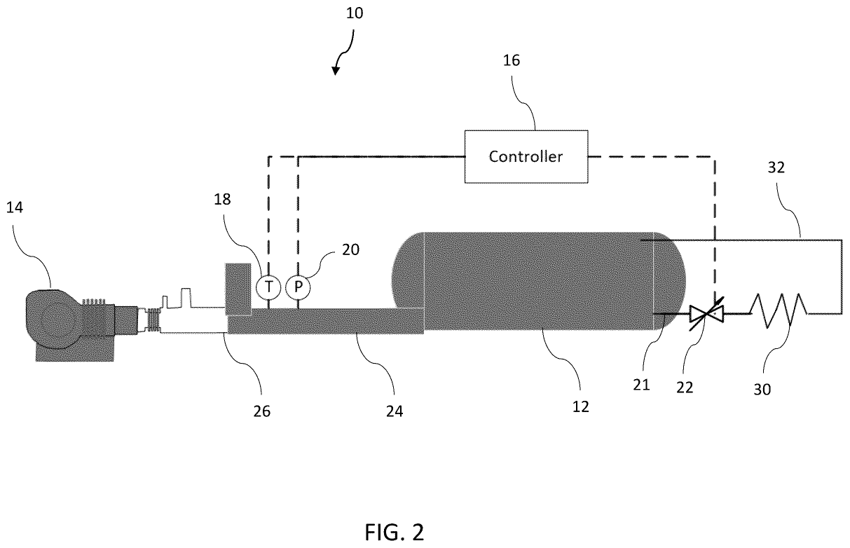

FIG. 2 shows an example of a cryogenic liquid transfer system 10 provided with a first embodiment of the NPSP control system of the disclosure. The liquid transfer system 10 includes a cryogenic liquid storage tank 12 and a cryogenic pump 14. The cryogenic pump 14 may be a centrifugal or reciprocating pump and is configured to pump cryogenic liquid from the storage tank 12 to be used in various downstream processes or to be collected as a product. As an example only, the cryogenic liquid may be liquid hydrogen.

A NPSP closed-loop control system regulates NPSP for the pump to keep the liquid entering the pump 14 from cavitating. The NPSP control system includes a programmable controller 16 configured to maintain and/or adjust the NPSP provided to the pump 14. The controller 16 is also configured to receive information from a temperature sensor 18 and a pressure sensor 20 and to control a pressure-building valve 22 separating the storage tank 12 from a pressure-building circuit. Additional sensors and valves associated with the controller 16 may be present in the fluid system 10 without departing from the scope of the disclosure. The controller 16 may be in communication with the sensors and valve(s) of the liquid transfer system 10 via a wired or wireless connection. Furthermore, a target NPSP can be pre-programmed or entered into and stored in the controller 16. In an embodiment, the desired NPSP may be the NPSPr provided with the pump's datasheet or a different pre-determined value.

When activated, the pump 14 causes liquid to exit the storage tank 12 through an outlet line 24 and travel towards the pump inlet 26. Liquid exits the pump 14 through an outlet (not shown) that is in fluid communication with various downstream devices or systems for processing, use or storage. As the liquid exits the storage tank 12, the liquid passes the temperature sensor 18 and pressure sensor 20, which are located near or at the pump inlet 26. The sensors 18 and 20 are configured to send temperature and pressure measurements of the fluid traveling at or near the pump inlet to the controller 16. Using the measurements received from the sensors 18 and 20, the controller determines the NPSP being provided to the pump 14. As an example only, since the fluid from bulk tank is known (for example Hydrogen), the temperature detected by the temperature sensor 18 (Tₛ) may be used by the controller 16 to determine the saturation pressure (Pₛₐₜ) such as by using a lookup table. The determined Pₛₐₜ may then be subtracted from the pressure measured by the pressure sensor 20 to determine the NPSP.

If the determined NPSP is lower than desired (lower than the target NPSP), the controller 16 directs the pressure-building valve 22 to open. This causes cryogenic liquid within the storage tank 12 to enter a pressure-building circuit to increase the pressure within the storage tank 12. In an embodiment, the pressure-building circuit includes a pressure-building coil 30. Cryogenic liquid from the liquid side of tank 12 may enter an inlet line 21, pass through pressure-building valve 22, and travel into the pressure-building coil 30 where the liquid is vaporized by ambient temperature. The vaporized stream is then return to the headspace of the storage tank 12 via return line 32 to increase the pressure with the storage tank 12. By increasing the pressure within the storage tank 12, the NPSP for the pump is increased.

On the other hand, if the calculated NPSP is higher than desired, the controller 16 may close or keep pressure-building valve 22 closed, preventing liquid from entering the pressure-build circuit so that the pressure within the storage tank 12 decreases as liquid is pumped therefrom.

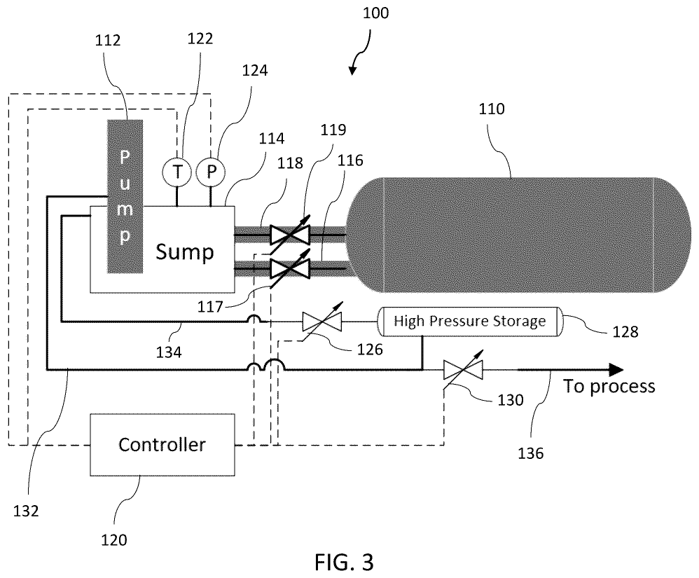

FIG. 3 shows another example of a cryogenic transfer system 100 provided with a second embodiment of the NPSP closed-loop control system of the disclosure. The liquid transfer system 100 includes a cryogenic liquid storage tank 110 and a cryogenic pump 112, with the pump submerged in a sump 114 that receives cryogenic liquid from the storage tank 110. The cryogenic pump 112 may be a centrifugal or reciprocating pump and is configured to pump cryogenic liquid from the sump 114 (and thus from storage tank 110) to be used in various downstream processes or to be collected as a product. As an example only, the cryogenic liquid may be liquid hydrogen.

The sump 114 may be isolated from, or placed communication with (for refilling of the sump), the storage tank by manipulating a liquid isolation valve 117 that is positioned within a liquid feed line 116 and a vapor isolation valve 119 that is positioned within a vapor return line 118.

The NPSP control system associated with liquid transfer system 100 includes a programmable controller 120 configured to maintain and/or adjust the NPSP provided to the pump 112. More specifically, the controller is configured to receive information from a temperature sensor 122 and a pressure sensor 124 and to control a pressure-building circuit valve 126 separating the sump 114 from a high-pressure fluid storage tank 128. Additionally, the controller 120 is configured to control liquid isolation valve 117, vapor isolation valve 119, and an optional discharge or liquid delivery valve 130, where the liquid delivery valve is positioned within a process/product line 136 and controls the delivery of plumped liquid to a downstream process, use or storage. Additional sensors and valves associated with the controller 120 may be present in the liquid transfer system 100 without departing from the scope of the disclosure. The controller 120 may be in communication with the various sensors and valves of liquid transfer system 100 via a wired or wireless connection.

As explained below, a high-pressure fluid stream from the high-pressure storage tank 128 is used to provide the target NPSP for pump 112. A target NPSP can be pre-programmed or entered into and stored in the controller 120. In an embodiment, the target NPSP may be the NPSPr provided with the pump's datasheet, or a different pre-determined value.

During use, the controller 120 opens liquid isolation valve 117 and vapor isolation valve 119 (for vapor return from the sump to the bulk tank) to fill the sump 114 with liquid from the storage tank 110 via the liquid feed line 116. Pump 112 may then pump the liquid out of the sump 114 through discharge line 132.

Temperature and pressure may be measured inside the sump 114 by the temperature and pressure sensors 122 and 124 and the measurements may be sent to the controller 120. Using the temperature and pressure measurements received from the sensors 122 and 124, as described above for the embodiment of FIG. 2, the controller 120 may determine the NPSP provided to the pump 112.

If the determined NPSP is lower than the target NPSP, the controller 120 may adjust the pressure in the sump 114 by introducing a high-pressure fluid stream from the high-pressure storage tank 128.

In the illustrated embodiment, the high-pressure storage tank 128 may be filled with fluid from the discharge line 132 of the pump 112. As an example only, in embodiments including the optional discharge valve 130, the controller 120 may shut discharge valve 130 to direct discharge fluid through discharge line 132 into the high-pressure storage tank 128. In some alternative embodiments, where valve 130 is not present, the pressure in line 132 is always higher than the pressure within sump 114, so that the valve 130 does not need to be closed to direct discharge fluid from line 132 into the sump.

Alternatively, the high-pressure storage tank 128 may be filled with a high-pressure fluid from an external source, where the fluid may be the same as, or different from the cryogenic liquid stored in tank 110. The fluid within high pressure storage 128 may be in the liquid or vapor phase.

Regardless if valve 130 is present or not, to increase the NPSP, the controller may direct a pressure-building valve 126 to open, allowing a high-pressure fluid stream to enter the sump 114 via pressure-building line 134, until the temperature and pressure sensors 122 and 124 indicate that the required NPSP has been reached. The pressure-building valve 126 may then be closed.

In instances when the calculated NPSP is higher than desired, the controller 120 may close or keep pressure-building valve 126 closed so that the pressure within the storage tank 110 decreases as liquid exits. In an embodiment, the controller 120 may also or alternatively open valve 119, allowing vapor in the sump 114 to return to the storage tank 110 via vapor return line 118, thus decreasing NPSP in the sump 114 for the pump 112.

If the calculated NPSP is at the desired NPSP, the controller may direct the discharge valve 130 (if present) to open, and the pumped liquid may exit via line 132 to be further processed, used within a system, or collected as a product downstream. In an embodiment where the delivery valve 130 is present, delivery valve 130 may remain open, allowing pumped liquid to exit the system, as the NPSP is adjusted by the controller. In another embodiment where the delivery valve 130 is present, the discharge valve 130 may be shut as the controller adjusts the NPSP.

There are several aspects of the present subject matter which may be embodied separately or together in the methods, devices, and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

While the preferred embodiments of the invention have been shown and described, it will be apparent to those skilled in the art that changes and modifications may be made therein without departing from the spirit of the invention, the scope of which is defined by the appended claims.

What is claimed is:

1. A cryogenic liquid transfer system comprising:
a storage tank configured to contain a cryogenic liquid;
a pump in fluid communication with the storage tank, wherein the pump is configured to pump liquid out of the storage tank;
a temperature sensor and a pressure sensor configured to measure a temperature and pressure of cryogenic liquid upstream of the pump;
a pressure-building circuit including a pressure-building valve; and
a controller, wherein the controller is configured to
determine a Net Positive Suction Pressure provided to the pump based on measurements from the temperature sensor and the pressure sensor and adjust the determined Net Positive Suction Pressure by manipulation of the pressure-building valve to provide a target Net Positive Suction Pressure to the pump.

2. The liquid transfer system of claim 1, wherein the controller is configured to open the pressure-building valve to increase the Net Positive Suction Pressure provided to the pump.

3. The liquid transfer system of claim 1, wherein the controller is configured to close the pressure-building valve to decrease or maintain the Net Positive Suction Pressure provided to the pump.

4. The liquid transfer system of claim 1, wherein the controller is configured to store the target Net Positive Suction Pressure.

5. The liquid transfer system of claim 1, wherein the pump includes an outlet in fluid communication with a discharge line.

6. The liquid transfer system of claim 1, wherein the pump is a centrifugal pump.

7. The liquid transfer system of claim 1, wherein the pump is a reciprocating pump.

8. The liquid transfer system of claim 1, wherein the pressure-building circuit is in direct fluid communication with the storage tank.

9. The liquid transfer system of claim 8, wherein the pressure-building circuit includes an inlet line in fluid communication with the storage tank and configured to receive a liquid from the storage tank, wherein the inlet line includes the pressure-building circuit valve, a pressure-building coil in fluid communication with the inlet line located downstream the valve, and an outlet line in direct fluid communication with the pressure-building coil configured to return a vapor stream to a headspace of the storage tank.

10. The liquid transfer system of claim 8, wherein the temperature sensor and pressure sensor are located near or at an inlet of the pump.

11. The liquid transfer system of claim 1, wherein the pump is submerged in a cryogenic liquid in a sump.

12. The liquid transfer system of claim 11, wherein the sump includes a liquid feed line in direct fluid communication with the storage tank and a vapor return line in direct fluid communication with the storage tank.

13. The liquid transfer system of claim 11, wherein the sump is filled with liquid from the storage tank.

14. The liquid transfer system of claim 11, wherein the temperature sensor and the pressure sensor are associated with the sump and are configured to measure the temperature and pressure of cryogenic liquid within the sump.

15. The liquid transfer system of claim 11, wherein the pressure-building circuit includes a pressure-building line including the pressure-building valve, the pressure-building line being in direct flow communication with the sump and a high-pressure storage tank.

16. The liquid transfer system of claim 15, wherein the high-pressure storage tank contains a high-pressure fluid.

17. The liquid transfer system of claim 16, wherein the high-pressure storage tank is in direct flow communication with the pump and is filled with cryogenic liquid from the pump.

18. The liquid transfer system of claim 17, wherein the discharge line includes a discharge valve and the controller is configured to close the discharge valve to direct pumped cryogenic liquid to the high-pressure storage tank from the pump.

19. The liquid transfer system of claim 16, wherein the high-pressure storage tank is filled with a high-pressure fluid from an external high-pressure fluid source.

20. The liquid transfer system of claim 11, further comprising a liquid isolation valve located in the liquid feed line and a vapor isolation valve located in the vapor return line, and wherein the controller is further configured to operate the liquid isolation valve and the vapor isolation valve.

21. The liquid transfer system of claim 20, wherein the controller is configured to open the vapor isolation valve to decrease the Net Positive Suction Pressure provided to the pump.

22. The liquid transfer system of claim 1, wherein the storage tank contains a cryogenic liquid.

23. The liquid transfer system of claim 22, wherein the cryogenic liquid is liquid hydrogen.

24. A method for preventing cavitation in a cryogenic liquid transfer system including a storage tank and a pump comprising the steps of:
determining a Net Positive Suction Pressure provided to the pump by measuring a temperature and a pressure of a cryogenic liquid upstream of the pump; and
adjusting the Net Positive Suction Pressure to a target Net Positive Suction Pressure based on the measured temperature and pressure.

25. The method of claim 24 further comprising the step of opening a pressure-building valve of a pressure-building circuit to increase the Net Positive Suction Pressure provided to the pump.

26. The method of claim 25 further comprising the step of vaporizing cryogenic liquid from the storage tank in the pressure-building circuit and directing a resulting vapor to a head space of the storage tank when the pressure-building valve is opened.

27. The method of claim 24, further comprising the steps of directing cryogenic liquid from the storage tank to a sump and submerging the pump in the cryogenic liquid in the sump.

28. The method of claim 27, wherein the step of determining a Net Positive Suction Pressure provided to the pump by measuring a temperature and a pressure of a cryogenic liquid upstream of the pump includes measuring a temperature and pressure of the cryogenic liquid in the sump.

29. The method of claim 27 further comprising the step of opening a pressure-building valve of a pressure-building circuit, where the pressure-building circuit includes a high-pressure storage tank, to increase the Net Positive Suction Pressure provided to the pump by pressurizing the sump with fluid from the high-pressure storage tank.

30. The method of claim 27 further comprising the step of directing liquid from the storage tank to the high-pressure storage tank using the pump to refill the high-pressure storage tank.

31. The method of claim 27 further comprising the step of refilling the high-pressure storage tank with a high-pressure fluid from an external high-pressure fluid source.

32. The method of claim 24, wherein the cryogenic liquid is liquid hydrogen.
